(19) United States
(12) Patent Application Publication
(10) Pub. No.: US 2025/0180181 A1
(43) Pub. Date: Jun. 5, 2025

(54) METHOD FOR OPERATING A LIGHTING DEVICE FOR A VEHICLE, A LIGHTING SYSTEM FOR A VEHICLE, AND VEHICLE

(71) Applicant: Ford Global Technologies, LLC, Dearborn, MI (US)

(72) Inventors: Lars Junker, Köln (DE); Lukas Richter, Köln (DE); Stefan Lingscheidt, Köln (DE); Christian Vossel, Cologne (DE)

(73) Assignee: Ford Global Technologies, LLC, Dearborn, MI (US)

(21) Appl. No.: 18/964,673

(22) Filed: Dec. 1, 2024

(30) Foreign Application Priority Data
Dec. 4, 2023 (DE) 102023133835.8

(51) Int. Cl. F21S 41/663; B60Q 1/08; B60Q 1/14; F21S 41/675

(52) U.S. Cl. CPC F21S 41/663; B60Q 1/08; B60Q 1/1423; F21S 41/675; B60Q 2300/112; B60Q 2300/21; B60Q 2300/40

(57) ABSTRACT

The disclosure relates in general to a method for operating a lighting device for a vehicle, a lighting system for a vehicle, and a vehicle. The lighting device has at least one lighting element, one actuator and one control device. The lighting element has a plurality of controllable segments with associated supply circuits. The control device has at least one control algorithm. A lighting zone produced by the lighting element is adapted on the basis of the control algorithm of the control device in such a way that the lighting zone produced by the lighting element coincides with a desired illumination zone. The control device adapts the lighting zone produced by the lighting element on the basis of a mechanical degree of actuation determined by the control algorithm and/or a virtual degree of actuation determined by the control algorithm.

### CROSS-REFERENCE TO RELATED APPLICATIONS

The present application claims priority to and the benefit of German Application No. 102023133835.8, filed on Dec. 4, 2023, which is hereby incorporated by reference herein in its entirety.

### FIELD

The disclosure relates in general to a method for operating a lighting device for a vehicle, a lighting system for a vehicle, and a vehicle.

The prior art includes tracking mechanisms for lighting devices to ensure that the light produced by a lighting device follows a roadway trajectory, for example. Thus, the illumination of the roadway areas ahead of a vehicle can be adapted, especially in the case of cornering, in order to ensure appropriate visibility conditions for the driver.

### BACKGROUND

WO 2021/170509 A1 and WO 2022/207578 A1 disclose generic methods for controlling a light pattern. The light pattern is divided up, and it is possible to modify widths of the different segments of the light pattern. Light intensity values of the first and second segment can be interpolated on the basis of a matrix arrangement of light pixels. According to WO 2022/207578 A1, a roadway profile can be taken into account. This is referred to as a “virtual cornering light” (also referred to as virtual bending).

U.S. Pat. No. 10,025,424 B2, EP 1 234 716 B1 and KR 10-1934750 B1 disclose generic lighting devices in which one component of the lighting device can be moved with motor assistance to adapt an illumination zone provided by the lighting device at least in respect of its orientation. This is referred to as a “mechanical cornering light” (also referred to as mechanical bending).

To adapt the illumination zone of a lighting device, known approaches therefore rely either on mechanical mobility of individual components of the lighting device or on modification of the light intensity values of individual light elements. The various approaches to implementation are motivated by the fact that, for example, a dazzle-free high beam can be implemented in an optimum manner by means of the virtual cornering light, while a dynamic cornering light can be implemented in an optimum manner by means of the mechanical cornering light. However, these approaches are based on different technical implementations. Hitherto, the overall approach to the operation of the lighting device is therefore based on choosing one of the two fundamentally different technical implementations. In this context, a particular technical implementation, i.e. either the mechanical or the virtual cornering light, is selected on the basis of a consideration of performance and/or focusing in terms of a functional group.

There is therefore a desire to eliminate or at least reduce the disadvantages of known methods and corresponding lighting systems. There is a desire to provide a method for operating a lighting device for a vehicle and a corresponding lighting system which allow a combination of the technically differing approaches of the mechanical and the virtual cornering light in order to reduce performance losses and to achieve synergistic effects in respect of the various advantages.

### SUMMARY OF THE DISCLOSURE

An object is achieved, for example, by the subjects of the independent patent claims. Advantageous embodiments are indicated in the dependent patent claims and in the following description, and each of these per se or in (sub)combinations can represent aspects of the disclosure. Some features are explained in light of methods, others in light of devices. However, the corresponding aspects are transferable among them as appropriate.

According to one aspect, some embodiments of the disclosure relate to a method for operating at least one lighting device for a vehicle. The lighting device has at least one lighting element, one actuator and one control device. The control device is coupled at least to the lighting element and the actuator. The lighting element has a plurality of controllable segments with associated supply circuits. The control device has at least one control algorithm. The method comprises at least the following step:
adapting a lighting zone produced by the lighting element on the basis of the control algorithm of the control device in such a way that the lighting zone produced by the lighting element coincides with a desired illumination zone.

In this process, the control device adapts the lighting zone produced by the lighting element on the basis of a mechanical degree of actuation determined by the control algorithm and/or a virtual degree of actuation determined by the control algorithm.

The mechanical degree of actuation indicates that the lighting zone produced by the lighting element is being adapted on the basis of a movement of the lighting element or a part thereof brought about by the actuator.

The virtual degree of actuation indicates that the lighting zone produced by the lighting element is being adapted on the basis of a variation of a duty cycle of the supply circuit for at least one segment of the lighting element.

This provides a method which advantageously combines the two implementation approaches, which are in principle technically different, in order for example to implement a common single control algorithm that can simultaneously achieve both a dazzle-free high beam and a dynamic cornering light. Consequently, the lighting zone produced by the lighting element can be adapted in a manner more appropriate to requirements than hitherto. Here, the possibilities for modification are increased over previous approaches since both the mechanical cornering light and the virtual cornering light can be used to adapt the lighting zone in a desired manner. This has the effect that it is possible to combine the advantages of the two solutions to technical implementation, which generally differ, thereby increasing the functionality and versatility of the lighting device in comparison with previous lighting devices. Hitherto, combining the various approaches has been prevented, in particular, by the fact that the use of a mechanical cornering light has an effect on the virtual cornering light. In the present case, use is made, in particular, of the control algorithm of the control device in order to compensate the interaction between the conflicting technical approaches so as to ensure an optimum solution for the adaptation of the lighting zone.

According to another aspect, some embodiments of the disclosure relate to a lighting system for a vehicle. The lighting system has at least one lighting element, one actuator and one control device. The control device is coupled at least to the lighting element and the actuator. The lighting element has a plurality of controllable segments with associated supply circuits. The control device has at least one control algorithm and is configured to adapt a lighting zone produced by the lighting element on the basis of the control algorithm of the control device in such a way that the lighting zone produced by the lighting element coincides with a desired illumination zone. The control device is configured to adapt the lighting zone produced by the lighting element on the basis of a mechanical degree of actuation determined by the control algorithm and/or a virtual degree of actuation determined by the control algorithm. The mechanical degree of actuation indicates that the lighting zone produced by the lighting element is being adapted on the basis of a movement of the lighting element brought about by the actuator. The virtual degree of actuation indicates that the lighting zone produced by the lighting element is being adapted on the basis of a variation of a duty cycle of the supply circuit for at least one segment of the lighting element.

The advantages that are made possible by the method elucidated above are attained in a corresponding manner also by the lighting system explained here. In particular, the lighting system provided is one that combines the two possibilities for implementation, which differ technically in principle, and can compensate the interaction between the differing technical implementations.

In the present case, a lighting device can be understood to mean the totality of the components required to operate the lighting device. This means that the lighting device is not reduced to the lighting means as such but also includes the control device and other components, e.g. the actuator.

The lighting system can have individual lighting devices or a plurality thereof. Individual components within the lighting system can be assigned jointly to a plurality of lighting devices. For example, the lighting system need only have a single control device. Typically, however, each lighting device has a lighting element to which a corresponding actuator is assigned.

The method can also be used to control the lighting devices of a lighting system jointly. Thus, the method can also be configured to jointly control the plurality of lighting devices of a lighting system of a vehicle. In this case, the lighting zone is produced jointly by the plurality of lighting devices or the lighting elements thereof.

In the present case, the lighting element denotes the totality of components that are configured to produce a light. The lighting element can have a plurality of individual, generally separate lighting means. In this context, a lighting means may be understood to mean an individual component that is configured to produce a light.

The segments of the lighting elements can refer to individual lighting means or to groups of lighting means that are combined as a unit. Identical supply circuits can be provided for the groups of lighting means in order to control all the lighting means of the group in the same way, e.g. in accordance with a parallel connection.

Supply circuits may be understood, in particular, to mean control circuits for the lighting element or individual segments of the lighting element. In particular, the supply circuits are configured to supply a voltage and a current for a segment of the lighting element, such that the segment of the lighting element is excited to emit light. The lighting zone of the lighting element is produced on the basis of the light emission of the totality of the segments of the lighting element. In particular, the supply circuits are such that the intensity of the light emission of a segment of the lighting element can be adapted. In other words, the luminous intensity, light intensity and, optionally also, the light color can be adapted by variation by means of the respective supply circuit.

The control device is preferably coupled to the supply circuits of the segments of the lighting element. The control device can then output control signals in order to influence the supply circuits, thus as a result enabling the emission properties of the segments to which the respective supply circuits are assigned to be adapted.

As an option, it is also possible to provide just a single supply circuit, which is assigned to all the segments of a lighting element and is configured to vary the supply parameters for the segments independently of one another.

Segmentation of the lighting element allows modification of individual zones of the overall lighting zone produced by the lighting element. This enables the lighting zone to be adapted in many different ways.

The lighting means preferably comprises a light-emitting diode (LED). Alternatively, other types of lighting means can also be used, e.g. halogen lamps or the like.

As an alternative to the actuator, it is also possible to provide other mechanical actuating elements, e.g. motors or other types of drives, e.g. magnetic drives, pneumatic drives or hydraulic drives, which are configured to move at least one component of the lighting device, in particular the lighting element or a part thereof.

In general, the control device has at least one data processing device, in which the control algorithm is stored or executed. In particular, the control device can be coupled to a storage device. Parts of the control algorithm can be stored in the storage device.

As an option, parts of the control algorithm may also be external to the control device. For example, parts of the control algorithm may be stored in an external server. The control device can have a communication device or be coupled to such a device to allow communication with an external server. Data exchange between the control device and the external server can then enable the execution of the control algorithm overall. This reduces the requirements on the control device. In addition it creates the possibility of executing the control algorithm centrally in an external server. Since the external server can be coupled to a plurality of control devices, it is possible in this way to expand the database for the control algorithm, which, as a consequence, can provide optimized decision behavior and thus an optimized control strategy on account of the larger database.

In the present case, the desired illumination zone can be understood to mean a spatial zone which can be illuminated in the best possible way by means of a lighting zone produced by the lighting device to ensure optimum visibility conditions for the driver of the vehicle. Typically, the desired illumination zone corresponds to a spatial zone of the roadway which extends in a forward direction from the vehicle to a certain distance, e.g. 20 m or more, preferably 35 m or more, as a further preference 50 m or more, as a further preference 100 m or more.

The mechanical degree of actuation and the virtual degree of actuation indicate percentages according to which a variation of the lighting zone produced by the lighting element is to be carried out. For example, the mechanical degree of actuation can indicate a percentage of a total displacement or rotation travel of the lighting element or of a part thereof made possible by the actuator.

The mechanical degree of actuation can also take account, in particular, of the actual position of the lighting element within the displacement or rotation travel made possible by the actuator.

In simple terms, the mechanical degree of actuation can indicate, for example, that the lighting zone produced by the lighting element is to be rotated by 5° in a certain direction or that the lighting element is to be displaced by 5 mm in a certain direction. This leads in general to a variation of the lighting zone produced by the lighting element. It may be necessary to take into account a transmission ratio here if the light emission produced by the lighting element is deflected, e.g. by means of at least one mirror. Thus, the rotation of the lighting element by 5° on the basis of the mirror, in particular if the mirror is spherically shaped, may lead to a rotation of the lighting zone produced by the lighting element by more than or less than 5° relative to a plane generated by the vehicle longitudinal axis of the vehicle vertical axis.

The precise effect of the movements of the lighting element by means of the actuator on the lighting zone produced by the lighting element can be ascertained by means of calibration measurements and stored in the control device. On the basis of the calibration, the mechanical degree of actuation can then be correspondingly adapted, e.g. by a proportionality factor.

The virtual degree of actuation can likewise indicate that the lighting zone produced by the lighting element is to be rotated by 5° in a certain direction. Alternatively, or cumulatively, the virtual degree of actuation may indicate that the light intensity of a partial area of the lighting zone produced by the lighting element is to be increased or to be reduced. Therefore, the control device may output corresponding control signals to the supply circuits that are assigned to the corresponding segments of the lighting element in order to obtain a modification of the lighting zone produced by the lighting element by variation of the control voltages and control currents for the segments of the lighting element. In the case where the lighting zone is to be arranged exclusively straight ahead with respect to the vehicle, for example, certain segments of the lighting element can be deactivated. If, however, e.g. when cornering, a modification of the lighting zone corresponding to a rotation about the vehicle vertical axis is desired, the virtual degree of actuation can indicate that certain segments of the lighting element are to be activated and possibly others are to be deactivated to ensure that the overall lighting zone which is then produced by the lighting element differs from the straightahead direction of the vehicle. On the contrary, the lighting zone can as a result correspond to a zone which corresponds to a rotation of the lighting zone about the vehicle vertical axis, i.e. in the horizontal plane generated by the vehicle longitudinal axis and the vehicle transverse axis. In respect of the virtual degree of actuation too, it is possible to take into account a transmission ratio brought about by a deflection of the light emission produced by the lighting element.

Ultimately, both the mechanical degree of actuation and the virtual degree of actuation can indicate a rotation of the lighting zone produced by the lighting element in a horizontal plane, starting from a normal direction. Here, the normal direction corresponds to the vehicle longitudinal axis. Thus, the lighting zone produced by the lighting element can be readjusted, in particular in the horizontal plane, relative to a roadway profile that is not rectilinear. In this context, of course, “readjusted” means that the lighting zone is adapted in such a way that the roadway section ahead of the vehicle is optimally illuminated.

In an optional embodiment, it is also possible, as a complementary or alternative measure, to take into account an adaptation of the lighting zone in respect of height and to specify it by means of the mechanical degree of actuation and the virtual degree of actuation. This means that the lighting zone can also be varied in a corresponding manner in the vertical direction, e.g. by means of a rotation about the vehicle transverse axis. The actuator can be configured to enable a corresponding movement of the lighting element. In this way, it is possible, for example, to compensate irregularities in the ground. In corresponding fashion, certain segments can be controlled in an appropriate manner by modification of the supply circuits in such a way that variation of the vertical components of the lighting zone is effectively ensured.

In one alternative, the mechanical degree of actuation and/or the virtual degree of actuation can indicate that an adaptation of the lighting zone produced by the lighting element should be carried out in a certain proportion, e.g. a percentage, on the basis of a certain mechanism, i.e. either the virtual cornering light or the mechanical cornering light.

The control algorithm preferably takes into account a mechanical threshold value for the mechanical degree of actuation and/or a virtual threshold value for the virtual degree of actuation. The mechanical degree of actuation is less than the mechanical threshold value. The virtual degree of actuation is less than the virtual threshold value. This means that the mechanical threshold value and the virtual threshold value indicate upper limit values for the mechanical degree of actuation and the virtual degree of actuation. The threshold values make it possible to avoid unwanted configurations. For example, it is possible in this way to avoid a situation where the adaptation of the lighting zone takes place exclusively on the basis of the mechanical degree of actuation or exclusively on the basis of the virtual degree of actuation. It is thereby advantageously possible to avoid light artifacts, e.g. flickering, which could otherwise occur in special states of the system.

As an option, the mechanical threshold value and/or the virtual threshold value can be predetermined. As a result, the control system is particularly compact.

In one alternative, the mechanical threshold value and/or the virtual threshold value can also be adaptable. In this case, the threshold values can be adapted as required, e.g. in dependence on the respective vehicle configuration and/or the driving situation and/or other influences, e.g. external influences. For example, the adaptation can be carried out by the control device on the basis of acquired sensor data. Alternatively or cumulatively, the control device can receive additional information, such as information on the state of the vehicle, e.g. from a higher-level vehicle control device.

In some embodiments, the control algorithm also takes into account at least a roadway trajectory. The roadway trajectory can be detected, for example, by means of at least one sensor coupled to the control device.

As an option, the sensor can comprise at least one of a radar sensor, a LiDaR sensor (LiDaR: Light Detection and Ranging), a camera and an infrared camera. As a preferred option, a plurality of the said types of sensor may also be combined.

Alternatively or cumulatively, the vehicle can have a position sensor, which is coupled to the control device. On the basis of position data received by the position sensor, e.g. on the basis of a global navigation satellite system, information on the roadway trajectory can likewise be obtained. For this purpose, for example, the vehicle position determined can be compared with trajectory data that are stored in a storage device coupled to the control device.

In addition, in some embodiments, the roadway trajectory can also be received from an external cloud server, e.g. on the basis of a communication device coupled to the control device. The communication device is configured to communicate with the external server. The external server can then transmit the information on the roadway trajectory, especially if the vehicle position is transmitted to it.

In some embodiments, the desired illumination zone depends at least on the roadway trajectory. The desired illumination zone can then be adapted, in particular readjusted, especially with regard to the properties of the roadway trajectory. For example, the desired illumination zone can in this way be adapted relative to roadway trajectories that do not run in a straight line, e.g. relative to bend zones.

As an option, the method also comprises the following additional steps:
detecting an object within the desired illumination zone by means of a sensor coupled to the control device, and
adapting a light emission of at least one segment of the lighting element on the basis of the control algorithm of the control device in dependence on at least the detected object.

As an option, the lighting system or the lighting device additionally has a sensor coupled to the control device. The sensor is configured to detect an object within the desired illumination zone. The control device is configured to adapt a light emission of at least one segment of the lighting element on the basis of the control algorithm of the control device in dependence on at least the detected object.

In general, the lighting zone produced by the lighting element also at least partially illuminates an oncoming lane. By virtue of the development of the invention which is described here, it is possible to adapt the lighting zone produced by the lighting element in respect of the light emission to ensure that objects, e.g. oncoming vehicles or even vehicles in front, are not dazzled within the desired illumination zone by the light emission brought about by the lighting device. The sensor used to detect the object can be one of the types of sensor mentioned above.

As an option, a movement of the lighting element brought about by the actuator is taken into account by the control algorithm in the adaptation of the light emission. Here, the holistic nature of the method presented and of the lighting system is evident since the control device can take into account the previously determined parameters for the adaptation of the lighting zone, e.g. the mechanical degree of actuation and/or the virtual degree of actuation, when it is adapting the light emission of at least one segment of the lighting element in order to avoid dazzling an external object. In other words, this ensures a control algorithm which has situational awareness in order to adapt the light emission as required while taking into account the previously determined parameters.

The light emission of the at least one segment of the lighting element is preferably adapted on the basis of a variation of a duty cycle of the supply circuit for the at least one segment of the lighting element. Here, the advantages of combining the different technical approaches to implementation are evident. A mechanical movement of the lighting element generally leads only to variation of the lighting zone produced by the lighting element in respect of the outer limits. However, the detected object may be arranged within the lighting zone, i.e. surrounded on all sides by the lighting zone. A mechanical movement or rotation of the lighting element (mechanical cornering light, also referred to as mechanical bending) can then only provide a limited remedy to ensure that the light emission can be adapted in respect of the object. In contrast, the virtual control, on which the virtual cornering light (also referred to as virtual bending) is based, can fundamentally also be used to provide additional functionality. Here, the control on which the virtual cornering light is based can be used to reduce or avoid dazzling of objects within the actual lighting zone. For example, it is possible to reduce the light intensity of those segments of the lighting element of which the light emission affects a partial area of the lighting zone in which the object is arranged at this point in time. In other words, it is possible, by means of the control, on which the virtual cornering light is also based, to reduce the light emission precisely for those segments of the lighting element which correspond to the position of the object within the lighting zone. In this way, even partial areas situated on the inside of the lighting zone can be adapted in respect of their light emission to ensure that the object is not dazzled or that the light intensity in the region of the object is at least reduced. Thus, a lighting system is created which has increased functionality and increased comfort, including in respect of objects external to the vehicle.

In some embodiments, the control algorithm also takes into account at least a relative speed of the detected object when adapting the light emission. The relative speed is determined on the basis of the at least one sensor. The sensor can comprise one of the types of sensor mentioned. This enables the control device to determine how the movement of the object in the case of simultaneous movement of the vehicle is developing in respect of the lighting zone produced by the lighting device. Thus, the light emission of segments of the lighting element can be adapted in advance before the object even reaches the respective corresponding partial area of the lighting zone. The functionality of the method and of the lighting system can thereby be further enhanced on the basis of a further development of the situational awareness of the control algorithm.

In addition, the control algorithm preferably takes into account at least one of a traffic density, a vehicle speed and a steering behavior of a driver of the vehicle. This enables the situational awareness of the control algorithm to be further enhanced. In the case of a high traffic density, for example, provision can be made for the lighting zone produced by the lighting element to be adapted in any case in such a way that an oncoming lane is not illuminated or at least is less illuminated than in other driving situations. The vehicle speed can be used, for example, to determine to what distance ahead of the vehicle a roadway zone is to be illuminated by the lighting zone. Information on the steering behavior of the driver can be received from a higher-level vehicle control device, for example. If the driver exhibits unsteady (agile) steering behavior, the lighting zone produced by the lighting element can likewise be adapted in such a way that a tolerance range in respect of the oncoming lane is taken into account. Ultimately, this provides a control algorithm which has situational awareness, thus enabling the lighting zone produced by the lighting element to be adapted in many different ways as required to the respective driving situation.

The lighting system is preferably configured to carry out the method as described herein.

As an option, the method is designed as a computer-implemented method. This means that the essential control mechanisms can be performed with the aid of one or more data-processing devices.

According to another aspect, the disclosure also relates to a computer program product comprising commands that, when the program is executed by a computer, cause the latter to carry out the method as described herein. The advantages that are achieved by the method described herein are attained in a corresponding manner also by the computer program product.

According to an additional aspect, the disclosure also relates to a computer-readable storage medium comprising commands that, when the program is executed by a computer, cause the latter to carry out the method as described herein. The advantages that are achieved by the method described herein are attained in a corresponding manner also by the computer-readable storage medium.

According to another aspect, some embodiments of the disclosure also relate to a vehicle having a lighting system as described herein. The advantages that are achieved by the method described herein are attained in a corresponding manner also by the vehicle presented here.

For the purposes of the disclosure, vehicles can include, in particular, land vehicles, that is to say, inter alia, off-road and road vehicles such as passenger cars, buses, heavy goods vehicles and other utility vehicles. Vehicles can be manned or unmanned.

All the features explained with regard to the various aspects can be combined individually or in (sub)combinations with other aspects.

### BRIEF DESCRIPTION OF THE DRAWINGS

The disclosure and other advantageous embodiments and further developments thereof are described and explained in greater detail below with reference to examples illustrated in the drawings. In the drawings:

FIG. 1 shows a simplified schematic illustration of a vehicle having a lighting system according to one embodiment of the disclosure, and

FIG. 2 shows a simplified schematic illustration of a method for operating a lighting device for a vehicle according to one embodiment of the disclosure.

### DETAILED DESCRIPTION

The following detailed description in conjunction with the attached drawings, in which identical numerals indicate identical elements, is intended as a description of various embodiments of the subject matter disclosed and is not intended to represent the individual embodiments. Each embodiment described in this disclosure serves merely as an example or illustration and should not be interpreted as preferred or advantageous over other embodiments. The illustrative examples contained herein do not make any claim to completeness and do not limit the subject matter claimed to the precise forms disclosed. Various modifications of the embodiments described are readily apparent to a person skilled in the art, and the general principles defined herein can be applied to other embodiments and applications without departing from the spirit and scope of the embodiments described. The embodiments described are therefore not limited to the embodiments shown but have the maximum possible area of application compatible with the principles and features disclosed here.

All the features disclosed below with reference to the exemplary embodiments and/or the accompanying figures can be combined individually or in any subcombination with features of the aspects of the disclosure, including features of preferred embodiments, provided that the combination of features obtained is worthwhile for a person skilled in the art in this technical field.

For the purposes of the disclosure, the phrase “at least one of A, B and C” means, for example, (A), (B), (C), (A and B), (A and C), (B and C) or (A, B and C), including all further possible combinations if more than three elements are presented. In other words, the term “at least one of A and B” generally means “A and/or B”, namely “A” alone, “B” alone or “A and B”.

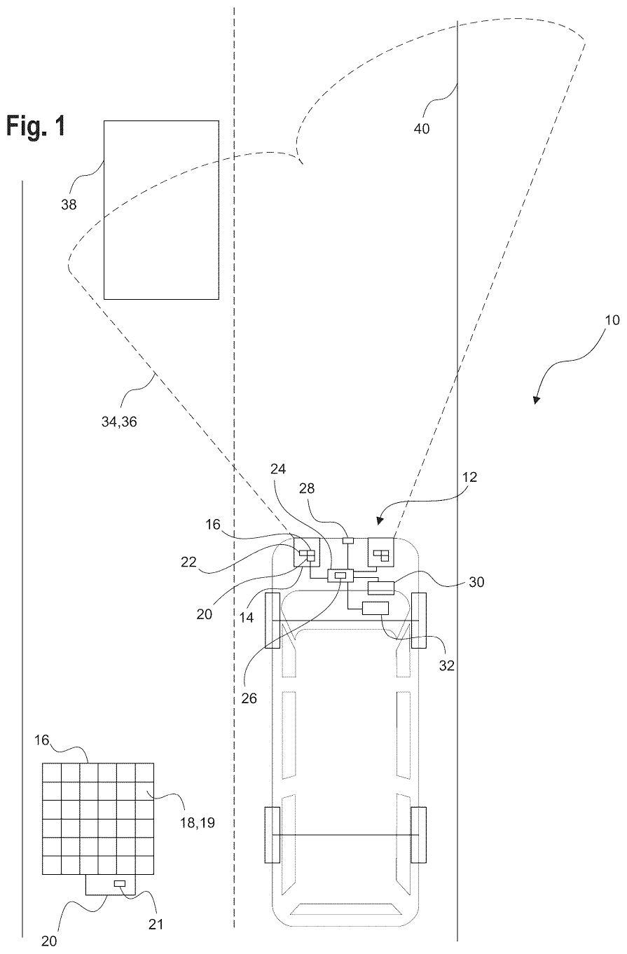

FIG. 1 shows a simplified schematic illustration of a vehicle 10 having a lighting system 12 according to one embodiment of the disclosure.

According to this embodiment, the lighting system 12 has two lighting devices 14 arranged in parallel. In general, the lighting system 12 may also have more or fewer lighting devices 14.

Each lighting device 14 comprises at least one lighting element 16, which has a plurality of segments 18 (see enlarged figure at the bottom left in FIG. 1). The segments 18 comprise individual or a plurality of lighting means 19, e.g. light-emitting diodes.

In addition, each lighting device 14 comprises a supply circuit 20, which has transistors 21 (switching devices). In general, each lighting device 14 can have a plurality of supply circuits 20, which are assigned to individual segments 18, for example. According to the present embodiment, a common supply circuit 20 is assigned to all the segments 18 of the lighting element 16. The supply circuit 20 is configured to make available supply voltages and supply currents separately for the individual segments 18. The lighting means 19 of the segments 18 of the lighting element 16 can be excited to emit light by means of the supply circuit 20. Here, various parameters of the light emission can be influenced by variation by means of the supply circuit 20. For example, a switching frequency of the transistor 21 can be adapted in order to increase or reduce a supply voltage. As a consequence, the light emission can have an increased or reduced luminous intensity. In one alternative, the light color can be influenced, for example.

In addition, each lighting device 14 comprises at least one actuator 22. The actuator 22 is configured to make possible a movement of the lighting element 16 or of a part thereof. In particular, the movement can comprise a translation or a rotation.

In the present case, the lighting system 12 furthermore comprises a common control device 24 for all the lighting devices 14. The control device 24 has at least one data processing device and the control algorithm 26.

In addition, the lighting system 12 comprises at least one sensor 28. In general, the sensor 28 can also be a conventional vehicle sensor, to which the lighting system 12 is merely coupled. This means that the sensor 28 does not have to be assigned exclusively to the lighting system 12.

The sensor 28 can be a radar sensor, LiDaR sensor, a camera or the like, for example.

According to the present embodiment, the lighting system 12 furthermore additionally comprises a communication device 30, which is configured to enable bidirectional communication with an external unit, e.g. a server.

Moreover, according to the present embodiment, the lighting system 12 comprises a storage device 32, which is coupled to the control device 24. The storage device 32 can be used, for example, to store parts of the control algorithm 26 therein.

The control device 24 is furthermore coupled to the supply circuits 20, the actuators 22, the sensor 28, the communication device 30, the storage device 32 and optionally, via the communication device 30, to an external server (not illustrated here). As a consequence of the bidirectional communication with the external server, parts of the control algorithm 26 can be stored on the external server. This means that parts of the method explained below can run on the external server, in particular the decision processes of the control algorithm 26 as to what extent a lighting zone 34 produced by the lighting device 14 is to be adapted.

Having been excited to emit light, the lighting means 19 of the segments 18 of the lighting elements 16 produce a lighting zone 34 ahead of the vehicle 10. According to the configuration illustrated here, the lighting zone 34 produced coincides with the desired illumination zone 36. Here, the desired illumination zone 36 corresponds to the zone that is situated in front relative to the vehicle 10 and is to be illuminated by the lighting system 12 in order to ensure optimum visibility conditions for the driver of the vehicle 10.

The sensor 28 is configured to detect objects 38 that are arranged at least partially within the desired illumination zone 36. As an option, the sensor 28 can also be configured to detect objects 38 before they even enter the desired illumination zone 36. This means that the object 38 can be detected before it enters the desired illumination zone 36 on account of the relative movement of the vehicle 10 and of the object 38. The data acquired by the sensor 28 are transferred to the control device 24.

In accordance with the illustrative driving situation illustrated here, it can be seen, for example, that the lighting zone 34 is asymmetrical when measured with respect to the roadway trajectory 40. While that part of the roadway trajectory 40 that is primarily for the use of oncoming traffic is illuminated only for a relatively short distance from the vehicle 10, that part of the roadway trajectory 40 which corresponds primarily to the forward direction of the vehicle 10 is illuminated for a larger distance.

If the roadway trajectory 40 then has bends, the lighting system 12 is configured to adapt the desired illumination zone 36 to the roadway trajectory 40 in corresponding fashion and to readjust the lighting zone 34 produced by the lighting device 14 accordingly.

As an option, the vehicle 10 may also have a navigation signal receiver (not illustrated here), which may be coupled to the control device 24. As a consequence, signal data from a global satellite navigation system can be used to determine a vehicle position of the vehicle 10. For example, the vehicle position can be used to determine the roadway trajectory 40 ahead.

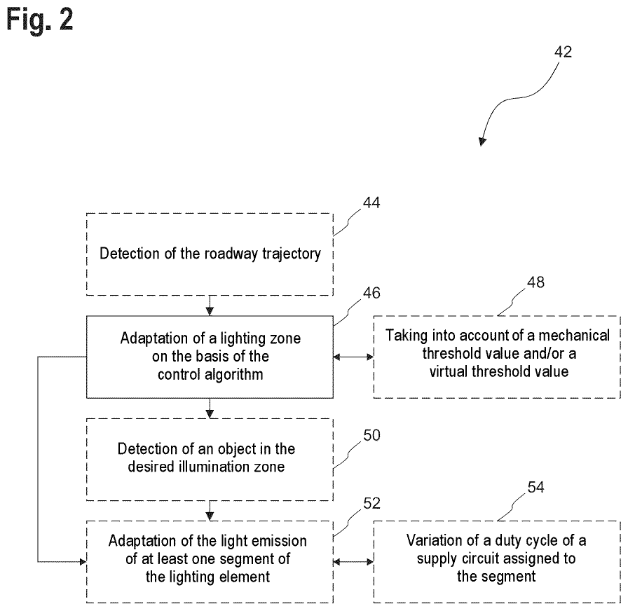

FIG. 2 shows a simplified schematic illustration of a method 42 for operating a lighting device 14 (or a lighting system 12 having a plurality of lighting devices 14) for a vehicle 10 according to one embodiment of the disclosure. Optional steps are illustrated in dashed lines.

According to optional step 44, the roadway trajectory 40 ahead of the vehicle 10 can be detected, e.g. by means of the sensor 28. The corresponding sensor data are then transferred to the control device 24, which can take into account the roadway trajectory 40 within the control algorithm 26 on the basis of the sensor data. As a consequence, the control algorithm 26 can adapt the desired illumination zone 36 in accordance with the roadway trajectory 40, for example.

In non-optional step 46, a lighting zone 34 produced by the lighting element 16 is adapted on the basis of the control algorithm 26 of the control device 24 in such a way that the lighting zone 34 produced by the lighting element 16 coincides with the desired illumination zone 36. This means that a difference between the desired illumination zone 36 and the lighting zone 34 is compensated by an adaptation by means of the control algorithm 26.

In this case, the control device 24 adapts the lighting zone 34 produced by the lighting element 16 on the basis of a mechanical degree of actuation determined by the control algorithm 26 and/or a virtual degree of actuation determined by the control algorithm 26. In this case, the mechanical degree of actuation corresponds to mechanical bending of the lighting zone 34. In this case, the virtual degree of actuation corresponds to virtual bending of the lighting zone 34. In particular, the mechanical degree of actuation indicates that the lighting zone 34 produced by the lighting element 16 is being adapted on the basis of a movement of the lighting element 16 brought about by the actuator 22. In contrast, the virtual degree of actuation indicates that the lighting zone 34 produced by the lighting element 16 is being adapted on the basis of a variation of a duty cycle of a supply circuit 20 for at least one segment 18 of the lighting element 16.

In step 46, the control algorithm 26 of the control device 24 thus determines in what way the lighting zone 34 can best be adapted to the desired illumination zone 36. Here, the higher-level objective of the control algorithm 26 is to ensure the best possible illumination of the roadway zone ahead of the vehicle 10. If the roadway has bends, it is possible, for example, to select a higher mechanical degree of actuation since the movement of the lighting element by means of the actuator 22 leads to a rotation of the lighting zone 34 in the horizontal plane relative to the vehicle longitudinal axis. If, on the other hand, it is ascertained that the roadway has only relatively small bend components, the virtual degree of actuation can be used, for example, to readjust the lighting zone 34 to the desired illumination zone 36 purely on the basis of an electronic control mechanism. For this purpose, the light intensity of the emitted light produced by the segments 18 can be adapted as required. For example, individual segments 18 can be activated or deactivated. Alternatively or cumulatively, the light emission of individual segments 18 can be reduced or increased. In particular, control of the light emission is possible by variation of a duty cycle of the supply circuit 20, which can adapt the duty cycle for the (plurality of) switching devices 21 in order to vary supply voltages and supply currents for individual segments 18.

In other words, the mechanical degree of actuation and the virtual degree of actuation determine the percentage according to which the readjustment of the lighting zone 34 relative to the desired illumination zone 36 takes place on the basis of a mechanical movement of the lighting element 16 or an electronically performed variation of the supply parameters. According to one example, the control algorithm 26 can determine, for example, that the mechanical degree of actuation is 30% and the virtual degree of actuation is 70%. With reference to the difference between the lighting zone 34 and the desired illumination zone 36, 30% of the readjustment can then be based on a mechanical movement of the lighting element 16 and 70% on an adaptation of the supply parameters of the segments 18 of the lighting element 16.

The mechanical degree of actuation and the virtual degree of actuation can also indicate the respective percentages in terms of other quantities, e.g. in respect of a degree of rotation of the lighting zone 34 that is to be brought about relative to the direction of the longitudinal extent of the vehicle. The mechanical degree of actuation can then indicate, for example, that the lighting element 16 is to be moved by the actuator 22 in such a way that a rotation of 15° with respect to the direction of the longitudinal extent of the vehicle is ensured, while the virtual degree of actuation can indicate that the supply parameters of the segments 18 are adapted in such a way that this leads to an effective additional rotation of 5°.

In terms of logic, the variation of the supply parameters of the segments 18 per se cannot bring about a rotation of the lighting zone 34. Here, this should be understood to mean that individual segments 18 are deactivated or activated or at least adapted in respect of their light emission, leading effectively to a variation of the lighting zone 34 produced by the overall lighting device 14 or the overall lighting system 12.

As a result of optional step 44, the control algorithm 26 can take into account the detected roadway trajectory 40 in step 46. The control algorithm 26 can also take into account other parameters and information in the process of control in step 46, e.g. information on the roadway trajectory 40, which the control device 24 has received from an external server.

The method 42 can be further developed by optional step 48 in which a mechanical threshold value and/or a virtual threshold value are taken into account by the control algorithm 26. The mechanical threshold value indicates an upper limit value for the mechanical degree of actuation. The virtual threshold value indicates an upper limit value for the virtual degree of actuation. As a consequence, the control mechanisms can be limited in the manner required, in order, for example, to exclude the occurrence of an exclusively mechanically based adaptation of the lighting zone 34.

According to optional step 50, the method 42 can be further developed in that an object 38 in the desired illumination zone 36 is detected. In this regard, detection can be accomplished by means of the sensor 28, for example.

As a consequence, it is possible, in optional step 52, for the light emission of at least one segment 18 of the lighting element 16 to be adapted on the basis of the control algorithm 26 of the control device 24 in dependence on at least the detected object 38. The light emission of the at least one segment 18 is preferably ensured by an electronically based adaptation of the supply parameters of the segment 18. For this purpose, the control device 24 can emit corresponding control signals to the supply circuit 20.

In step 52, the control algorithm 26 can take into account, in particular, the mechanical degree of actuation and the virtual degree of actuation from step 46. This means that the control algorithm 26 can take into account, for example, the mechanical movement of the lighting element 16 in order, in step 52, to adapt as required the variation of the light emission that is still to be accomplished. In this way, interactions that could otherwise lead to light artifacts can be avoided by means of the control algorithm 26.

At least in step 52 but optionally also in step 46, further information and data can also be taken into account by the control algorithm 26. For example, the control algorithm 26 can take into account the relative speed of the detected object 38 with respect to the vehicle 10. In addition, the control algorithm 26 can take into account the traffic density, the speed of the vehicle 10 or at least the steering behavior (agility) of a driver of the vehicle 10. This means that the data and parameters provided give the control algorithm 26 situational awareness for adapting the light emission as required. As an option, at least some of the said parameters and information can also be taken into account for the adaptation of the lighting zone 34 in step 46.

In particular, it is possible, according to the optional step 54, for the light emission to be adapted by means of variation of the duty cycle of a supply circuit 20 assigned to the segment 18. The variation of the duty cycle of a transistor 21 can be used to adapt supply parameters of the segment 18 in a particularly convenient and precise manner.

Thus, overall, a method 42 for operating a lighting device 14 (or a lighting system 12) of a vehicle 10 is provided which ensures a high degree of variability, the control mechanisms of which allow high precision of control and which has greater functionality than previous approaches.

The lighting system 12 and the method 42 enable the mechanical cornering light and the virtual cornering light of the lighting zone 34 to be combined, wherein the influences due to the mutual interactions between the different techniques can be compensated by means of the control algorithm 26, thus making it possible to avoid light artifacts (e.g. flickering). Consequently, a lighting system 12 is provided which allows both tracking of bends and a dazzle-free high beam.

Specific embodiments disclosed here, in particular the control device, use circuits (e.g. one or more circuits) to implement standards, protocols, methods or technologies disclosed here, to couple two or more components in a functional manner, to generate information, to process information, to analyze information, to generate signals, to code/decode signals, to convert signals, to transfer and/or receive signals, to control other devices etc. Circuits of any kind can be used.

In one embodiment, a circuit such as the control device comprises, inter alia, one or more data processing devices such as a processor (e.g. a microprocessor), a central processor unit (CPU), a digital signal processor (DSP), an application-specific integrated circuit (ASIC), a field-programmable gate array (FPGA), a system on a chip (SoC) or similar or any combinations thereof, and can comprise discrete digital or analog circuit elements or electronics or combinations thereof. In one embodiment, the circuit comprises hardware circuit implementations (e.g. implementations in analog circuits, implementations in digital circuits and the like and combinations thereof).

In one embodiment, circuits comprise combinations of circuits and computer program products with software or firmware instructions, which are stored on one or more computer-readable memories and interact to cause a device to carry out one or more of the protocols, methods or technologies described here. In one embodiment, the circuit technology comprises circuits such as microprocessors or parts of microprocessors that require software, firmware or the like in order to operate. In one embodiment, the circuits comprise one or more processors or parts thereof and the associated software, firmware, hardware and the like.

In this disclosure, reference may be made to quantities and numbers. Unless explicitly stated, such quantities and numbers should not be regarded as restrictive but should be regarded as examples of the possible quantities or numbers in the context of the disclosure. In this context, the term “a plurality” may also be used in the disclosure to refer to a quantity or number. In this context, the term “a plurality” means any number that is larger than one, e.g. two, three, four, five etc. The terms “about”, “approximately”, “in the vicinity of” etc. mean plus or minus 5% of the stated value.

Although the disclosure has been illustrated and described with reference to one or more embodiments, a person skilled in the art will be able to make equivalent changes and modifications after reading and understanding this description and the attached drawings.

We claim:

1. A method for operating a lighting device for a vehicle, comprising:
adapting a lighting zone produced by a lighting element on the basis of a control algorithm of a control device in such a way that a lighting zone produced by the lighting element coincides with a desired illumination zone:
wherein the control device adapts the lighting zone produced by the lighting element on the basis of a mechanical degree of actuation determined by the control algorithm and a virtual degree of actuation determined by the control algorithm;
wherein adapting the lighting zone includes providing a mechanical degree of actuation of the lighting element based on a movement of the lighting element by an actuator; and
wherein adapting the lighting zone includes providing a virtual degree of actuation of the lighting element based on of a variation of a duty cycle of the supply circuit for at least one segment of the lighting element.

2. The method of claim 1, further comprising:
applying at least one of a mechanical threshold value for the mechanical degree of actuation or a virtual threshold value for the virtual degree of actuation, wherein the mechanical degree of actuation is less than the mechanical threshold value, and wherein the virtual degree of actuation is less than the virtual threshold value.

3. The method of claim 1, wherein adapting the lighting zone further comprises:
determining a roadway trajectory, which is detected by at least one sensor operatively coupled to the control device.

4. The method of claim 3, wherein a desired illumination zone depends at least on the roadway trajectory.

5. The method of claim 1, further comprising:
detecting an object within the desired illumination zone using a sensor coupled to the control device; and
adapting a light emission of at least one segment of the lighting element based on the control algorithm of the control device in dependence on at least the detected object.

6. The method of claim 1, wherein a movement of the lighting element brought about by the actuator is considered by the control algorithm in the adaptation of the light emission.

7. The method of claim 1, wherein a light emission of at least one segment of the lighting element is adapted based on a variation of a duty cycle of the supply circuits for the at least one segment of the lighting element.

8. The method of claim 1, wherein, when adapting the light emission, a control algorithm considers at least a relative speed of the detected object, which is determined on the basis of at least one sensor.

9. The method of claim 1, wherein a control algorithm takes into account at least one of: traffic density, vehicle speed, or the steering behavior of a driver of the vehicle.

10. A lighting system for a vehicle, comprising:
a lighting element, wherein the lighting element has a plurality of controllable segments with associated supply circuits;
an actuator; and
at least one control device, wherein the control device is coupled to the lighting element and the actuator;
wherein the control device has at least one control algorithm that is configured to adapt a lighting zone produced by the lighting element on the basis of the control algorithm of the control device in such a way that the lighting zone produced by the lighting element coincides with a desired illumination zone;
wherein the control device is configured to adapt the lighting zone produced by the lighting element based on a mechanical degree of actuation determined by the control algorithm and/or a virtual degree of actuation determined by the control algorithm;
wherein the mechanical degree of actuation indicates that the lighting zone produced by the lighting element is being adapted on the basis of a movement of the lighting element brought about by the actuator; and
wherein the virtual degree of actuation indicates that the lighting zone produced by the lighting element is being adapted on the basis of a variation of a duty cycle of the supply circuit for at least one segment of the lighting element.

11. The lighting system of claim 10, wherein the lighting system additionally has a sensor, which is coupled to the control device and is configured to detect an object within the desired illumination zone, and wherein the control device is configured to adapt a light emission of at least one segment of the lighting element based on the control algorithm of the control device in dependence on at least the detected object.

12. The lighting system of claim 10, wherein the control device is configured to determine a roadway trajectory, and wherein a desired illumination zone depends at least on the roadway trajectory.

13. The lighting system of claim 10, wherein a light emission of at least one segment of the lighting element is adapted based on a variation of a duty cycle of the supply circuits for the at least one segment of the lighting element.

14. The lighting system of claim 10, wherein, when adapting the light emission, a control algorithm takes into account at least a relative speed of the detected object, which is determined on the basis of at least one sensor.

15. The lighting system of claim 10, wherein a control algorithm takes into account at least one of a traffic density, a vehicle speed and a steering behavior of a driver of the vehicle.

16. A vehicle having a lighting system, comprising:
a lighting element, wherein the lighting element has a plurality of controllable segments with associated supply circuits;
an actuator; and
at least one control device, wherein the control device is coupled to the lighting element and the actuator;
wherein the control device has at least one control algorithm that is configured to adapt a lighting zone produced by the lighting element on the basis of the control algorithm of the control device in such a way that the lighting zone produced by the lighting element coincides with a desired illumination zone;
wherein the control device is configured to adapt the lighting zone produced by the lighting element based on a mechanical degree of actuation determined by the control algorithm and/or a virtual degree of actuation determined by the control algorithm;
wherein the mechanical degree of actuation indicates that the lighting zone produced by the lighting element is being adapted based on a movement of the lighting element brought about by the actuator; and
wherein the virtual degree of actuation indicates that the lighting zone produced by the lighting element is being adapted based on a variation of a duty cycle of the supply circuit for at least one segment of the lighting element.

17. The vehicle of claim 16, wherein the control device is configured to determine a roadway trajectory, and wherein a desired illumination zone depends at least on the roadway trajectory.

18. The vehicle of claim 16, wherein the lighting system additionally has a sensor, which is coupled to the control device and is configured to detect an object within the desired illumination zone, and wherein the control device is configured to adapt a light emission of at least one segment of the lighting element based on the control algorithm of the control device in dependence on at least the detected object.
